(19) United States
(12) Patent Application Publication
(10) Pub. No.: US 2024/0327242 A1
(43) Pub. Date: Oct. 3, 2024

(54) TRANSITION METAL PRECURSOR FOR PREPARING CATHODE ACTIVE MATERIAL

(71) Applicant: L&F CO., LTD., Daegu (KR)

(72) Inventors: Sung Kyun CHANG, Daegu (KR); Sun Hong PARK, Daegu (KR); Hyun Do JEONG, Daegu (KR)

(21) Appl. No.: 18/578,092

(22) PCT Filed: Jul. 18, 2022
(86) PCT No.: PCT/KR2022/010423

§ 371 Date: Feb. 14, 2024

(30) Foreign Application Priority Data
Jul. 26, 2021 (KR) 10-2021-0098014

(51) Int. Cl. C01G 53/00; H01M 4/525

(52) U.S. Cl. CPC C01G 53/50; C01G 53/40; H01M 4/525; C01P 2002/52; C01P 2004/03; C01P 2004/52; C01P 2004/53; C01P 2004/61; C01P 2006/11; C01P 2006/12; C01P 2006/40

(57) ABSTRACT

Disclosed is a transition metal-containing precursor for preparing a cathode active material for a lithium secondary battery, wherein the transition metal-containing precursor includes a first precursor and a second precursor having an average particle diameter (D50) smaller than that of the first precursor, and has a ratio of a BET of the first precursor to a BET of the second precursor (BET of first precursor/BET of second precursor) of 0.3 to 3.5.

### TECHNICAL FIELD

The present invention relates to a transition metal precursor for preparing a cathode active material, and more specifically, to a transition metal precursor including two or more types of precursors having different average particle diameters and a BET ratio therebetween within a specific range.

### BACKGROUND ART

A lithium secondary battery includes, as main elements, a cathode active material, an anode active material, an electrolyte, and a separator. Thereamong, the cathode active material is the most essential element for producing secondary batteries and may be classified into lithium cobalt oxide (LCO), lithium nickel cobalt manganese oxide (NCM), lithium nickel cobalt aluminum oxide (NCA), lithium manganese oxide (LMO), lithium iron phosphate (LFP), or the like depending on the constituent ingredients thereof.

Recently, in an attempt to improve the performance of lithium secondary batteries, there has been an increasing need for high-capacity and high-density cathode active materials. For this purpose, a cathode active material that is imparted with improved mixture density by blending a plurality of cathode active materials in a bi- or tri-modal form or the like has been suggested.

However, the blended cathode active material is prepared by blending a plurality of cathode active materials produced by separately sintering a plurality of types of precursors and thus may cause problems of increased process costs and decreased productivity compared to cost.

Therefore, co-sintering of simultaneously sintering a mixture of a plurality of types of precursors at a specific ratio in the precursor stage was suggested, instead of blending the cathode active materials. In this co-sintering method, it is important to set conditions to control the powder properties of the precursor particles by each size to provide uniform lithium (Li) diffusion. Li diffusion of the lithium precursor into the transition metal precursor may be affected by the specific surface area, particle diameter, porosity, density, and the like of the transition metal precursor.

As such, the plurality of types of transition metal precursors may have different Li diffusion properties. Therefore, in the co-sintering method in which a single sintering temperature is applied to a plurality of types of transition metal precursors, the single sintering temperature may not act as the optimal temperature for Li diffusion into all types of transition metal precursors. This may be the problem of co-sintering used to improve the characteristics and productivity of the cathode active material.

Therefore, there is an increasing need for technology that can solve these problems.

### DISCLOSURE

### Technical Problem

Therefore, the present invention has been made to solve the above and other technical problems that have yet to be solved.

After repeated extensive research and various experiments, the present inventors found that, when, in a transition metal precursor including precursors having different average particle diameters, the precursors are designed to satisfy specific surface area conditions, a cathode active material having excellent properties due to high productivity can be obtained by co-sintering at a single sintering temperature and the present invention was completed based thereon.

### Technical Solution

In accordance with an aspect of the present invention, provided is a transition metal-containing precursor for preparing a cathode active material for lithium secondary batteries, wherein the transition metal-containing precursor includes a first precursor and a second precursor having an average particle diameter (D50) smaller than that of the first precursor, and has a ratio of a BET of the first precursor to a BET of the second precursor (the BET of first precursor/the BET of second precursor) of 0.3 to 3.5.

In general, cathode active materials for lithium secondary batteries are prepared by firing a precursor containing a transition metal (“transition metal precursor”) and a precursor containing lithium (“lithium precursor”) at a high temperature in an oxidizing atmosphere such as air. The transition metal precursor may be any one of transition metal oxides, hydroxides, oxyhydroxides and various salts, and the lithium precursor may be any one of lithium carbonates and hydroxides.

In general, the diffusivity of lithium into the transition metal precursor during sintering (firing) is known to be affected by various factors such as specific surface area, particle diameter, and density of the transition metal precursor. As an example of the various factors, the specific surface area may be proportional to lithium diffusivity. Therefore, in general, a small particle diameter precursor that may have a higher specific surface area than a large particle diameter precursor may have higher lithium diffusivity than that of the large particle diameter precursor.

Here, the lithium diffusion characteristics of the precursor may result from a combination of various factors including specific surface area and particle diameter, rather than any one of various factors.

As such, when a combination of the transition metal precursor with the lithium precursor (lithium source) is sintered, the precursors have different lithium diffusivities depending on factors such as specific surface area. Therefore, each precursor should be sintered at the optimal temperature in consideration of lithium diffusivity to provide a cathode active material having the desired characteristics.

Therefore, the present invention includes a transition metal precursor for a cathode active material in which lithium diffusion can be evenly optimized on all types of transition metal precursors present therein, rather than being concentrated on any one transition metal precursor, due to the set single sintering temperature.

In other words, by designing precursors having larger particle diameter ranges to have a sufficient specific surface area and designing precursors having small particle diameter ranges to not have an excessive specific surface area in order to reduce the difference in lithium diffusivity between plural types of precursors having different particle diameter ranges due to the general characteristic that a specific surface area is inversely proportional to a particle diameter, a precursor for a cathode active material in which all types of the present precursors exhibit optimal lithium diffusivity even when sintered at one appropriate temperature (single sintering temperature) can be provided.

Therefore, the present invention provides a transition metal precursor for preparing a cathode active material that includes two or more types of precursors having different average particle diameters to provide a combination of different active materials to improve the mixture density of the cathode active material, and in particular, wherein the BET conditions of the precursors are set to the specific ranges defined above in order to improve the uniformity of lithium diffusion between the precursors to enable co-sintering including simultaneously firing at a single temperature. This enables preparation of a cathode active material with high mixture density and excellent properties with high productivity.

Therefore, according to the present invention, the ratio of the BET of the first precursor having a larger average particle diameter to the BET of the second precursor having a smaller average particle diameter falls within the range of 0.3 to 3.5, preferably within the range of 0.5 to 2.7, and more preferably within the range of 0.5 to 2.0 as defined above. The setting of the ratio within these ranges imparts a relatively sufficient specific surface area to the first precursor having a larger particle diameter even in consideration of various factors that affect lithium diffusion, such as particle diameter and density, other than the specific surface area, and thus imparts sufficient lithium diffusion characteristics thereto and thus prevents lithium diffusion characteristics of the second precursor having a smaller particle diameter from excessively increasing.

As a result, the transition metal precursor according to the present invention may be configured to reduce the difference in lithium diffusivity between the first precursor and the second precursor and may optimize lithium diffusivity of all types of precursors even when sintered at a single appropriate sintering temperature, thus providing a cathode active material with high density and high capacity through a simplified production process and an increased mixture density of the cathode active material.

In a specific embodiment, a ratio of an average particle diameter (D50) of the first precursor to an average particle diameter (D50) of the second precursor (average particle diameter of the first precursor/average particle diameter of the second precursor) may be 1.2 or more. When the ratio is less than 1.2, the mixture density of the cathode active material may decrease due to the formation of excess space between the precursor with a large particle diameter and the precursor with a small particle diameter. Preferably, the ratio of the average particle diameter (D50) of the first precursor to the average particle diameter (D50) of the second precursor may be in the range of 1.2 to 10.

As to the sizes of these precursors, for example, the average particle diameter (D50) of the first precursor may be in the range of 10 μm to 20 μm, and the average particle diameter of the second precursor may be in the range of 2 μm to 8 μm, but the sizes are particularly not limited thereto.

In a specific embodiment, the BET of the first precursor may be 5.5 m²/g to 12.0 m²/g, the BET of the second precursor may be 3.5 m²/g to 16.0 m²/g, and a mix ratio of the first precursor to the second precursor may be a weight ratio of 9:1 to 6:4 (first precursor:second precursor). The BET and mix ratio may be appropriately set within the range of the BET ratio defined above depending on the desired characteristic conditions of the cathode active material.

As can be seen from the examples described later, the average particle diameter and BET of the precursor are controlled depending on various factors such as pH, ammonia concentration, stirring speed, temperature, and reaction time during the precursor preparation process. For example, when the pH during the coprecipitation process or ammonia concentration increases, the BET decreases. However, as described above, the average particle diameter and BET are determined by a combination of various factors and thus the desired setting ranges may be obtained through microscopic adjustment of conditions.

In terms of morphology, the first precursor and the second precursor constituting the transition metal precursor according to the present invention may have different lithium diffusivities at a single sintering temperature due to different specific surface areas. Therefore, by adjusting the difference in specific surface area to an appropriate range, both the first precursor and the second precursor can be formed into a shape to provide satisfactory lithium diffusivity even at a single sintering temperature. For example, the shape may be selected from a needle, a rod, a rod in which spaces between primary particles are filled, a plate, and the like. In addition, the first precursor and the second precursor may have the substantially same shape or may have different shapes from each other.

In a specific embodiment, the first precursor may have a tap density (TD) of 1.9 g/cc or less. When the tap density is higher than 1.9, the particle may have a denser inside and the surface morphology of the particle may change. This may inhibit lithium diffusion. In addition, the second precursor may have a TD of 1.2 or more. When the TD is less than 1.2, the proportion of pores present inside the particle may increase, which is not suitable for the configuration of the present invention to appropriately limit the BET of the small particle diameter precursor.

Specifically, at least one of the first precursor or the second precursor may include the chemical composition of the following Formula 1:

Ni_{1-(a+b+c)}CoₐMn_{b}M_{c}(OH_{1-d})₂ (1)
wherein M includes one or two or more elements selected from the group consisting of B, Al, Ti, Sc, V, Cr, Fe, Y, Cu, Zr, Nb, Mo, Tc, Ru, Rh, Ag, Pd, P, and W; and
a, b, c, and d satisfy 0≤a<0.4, 0≤b<0.4, 0≤c<0.4, and 0≤d≤0.5, respectively, with the proviso of 0<a+b and 0<a+b+c≤0.4.

The chemical compositions of the first precursor and the second precursor may be the same as or different from each other.

The present invention also provides a cathode active material for a lithium secondary battery prepared by co-sintering the transition metal precursor and a lithium precursor.

Technical details about the preparation method of the lithium precursor and the cathode active material prepared therefrom are known in the art and thus descriptions thereof will be omitted herein.

### Effects of the Invention

As described above, the transition metal precursor according to the present invention is a mixture of multiple types of precursors having different average particle diameters and is designed to optimize Li diffusion of all of the multiple types of constituent precursors, thus improving the electrochemical properties of the cathode active material owing to high mixture density, optimizing Li diffusion even at a single sintering temperature during co-sintering, and enabling preparation of cathode active materials with excellent properties with high productivity.

### BRIEF DESCRIPTION OF DRAWINGS

FIG. 1 is an SEM image showing a first precursor according to Example 1;

FIG. 2 is an SEM image showing a first precursor according to Example 2;

FIG. 3 is an SEM image showing a first precursor according to Example 3;

FIG. 4 is an SEM image showing second precursors according to Examples 1 and 4;

FIG. 5 is an SEM image showing a second precursor according to Example 2;

FIG. 6 is an SEM image showing a second precursor according to Example 3;

FIG. 7 is an SEM image showing a first precursor according to Example 4;

FIG. 8 is an SEM image showing a precursor for a cathode active material according to Example 1;

FIG. 9 is a PSD particle diameter distribution graph of the precursor for the cathode active material according to Example 1;

FIG. 10 is an SEM image showing a precursor for a cathode active material according to Example 4;

FIG. 11 is a PSD particle diameter distribution graph of the precursor for the cathode active material according to Example 4;

FIG. 12 is an SEM image showing a first precursor according to Comparative Example 1;

FIG. 13 is an SEM image showing a first precursor according to Comparative Example 2;

FIG. 14 is an SEM image showing a second precursor according to Comparative Example 1;

FIG. 15 is an SEM image showing a second precursor according to Comparative Example 2;

FIG. 16 is an SEM image showing a cathode active material prepared using the precursor of Example 1; and

FIG. 17 is an SEM image showing a cathode active material prepared using the precursor of Example 4.

### BEST MODE

Hereinafter, the present invention will be described in more detail with reference to the following examples. These examples should not be construed as limiting the scope of the present invention.

### Example 1

### <Precursor Preparation>

An aqueous metal salt solution with a Ni:Co:Mn ratio of 90:5:5 was continuously supplied along with an aqueous solution of ammonia and caustic soda to a 500 L cylindrical reactor. The pH of the resulting mixture in the reactor was adjusted to 12.0 to 12.1, the ammonia concentration in the reactor was adjusted to a concentration to 4,000 to 5,000 ppm and synthesis was performed by coprecipitation at a stirring speed of 380 rpm and at 60° C. for 30 hours. The synthesized result was washed, filtered and dried at 120° C. for 24 hours. As a result, a composite transition metal hydroxide powder (first precursor) with a D50 of 10 μm was prepared.

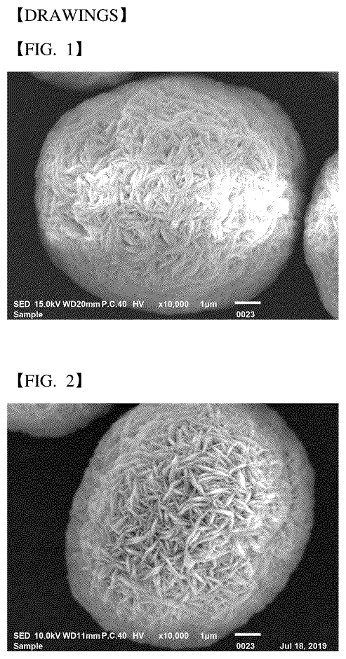

The SEM image of the first precursor thus prepared is shown in FIG. 1 and it can be seen from FIG. 1 that the primary particles constituting the secondary particles have a needle shape.

In addition, a composite transition metal hydroxide powder (second precursor) with a D50 of 4 μm was prepared in the same manner as in the first precursor except that the pH of the synthesized result in the reactor was adjusted to 12.5 to 12.6 and the ammonia concentration in the reactor was adjusted to 5,000 to 6,000 ppm.

The SEM image of the second precursor thus prepared is shown in FIG. 4 and it can be seen from FIG. 4 that the primary particles constituting the secondary particles have a rod shape.

### <Active Material Preparation>

The first and second precursors prepared above were supplied to a mixing tank at a weight ratio of 8:2, and LiOH was added thereto at a Li molar ratio of 1.03, followed by synthesis at a temperature of 740° C. for 18 hours to form a cathode active material.

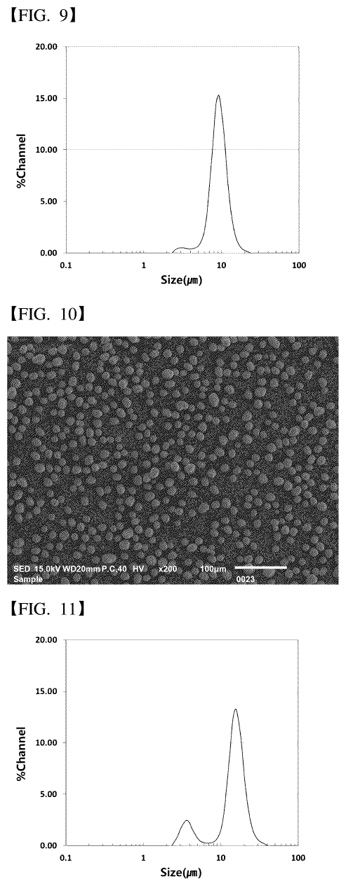

FIG. 8 is an SEM image showing a combination of the first precursor and the second precursor. It can be seen from FIG. 8 that large-diameter and small-diameter particles are combined and the combination of the large-diameter and small-diameter precursors can be seen from the results of PSD particle diameter distribution analysis of FIG. 9.

An SEM image of the cathode active material prepared from the first and second active materials is shown in FIG. 16.

### Example 2

A composite transition metal hydroxide powder (first precursor) with a D50 of 10 μm was prepared in the same manner as in Example 1 except that the pH of the synthesized result in the reactor was adjusted to 11.9 to 12.0 and the ammonia concentration in the reactor was adjusted to 4,000 to 5,000 ppm.

The SEM image of the first precursor thus prepared is shown in FIG. 2 and it can be seen from FIG. 2 that the primary particles constituting the secondary particles have a needle shape.

A composite transition metal hydroxide powder (second precursor) with a D50 of 4 μm was prepared in the same manner as in Example 1 except that the pH of the synthesized result in the reactor was adjusted to 11.8 to 11.9 and the ammonia concentration in the reactor was adjusted to 3,000 to 4,000 ppm.

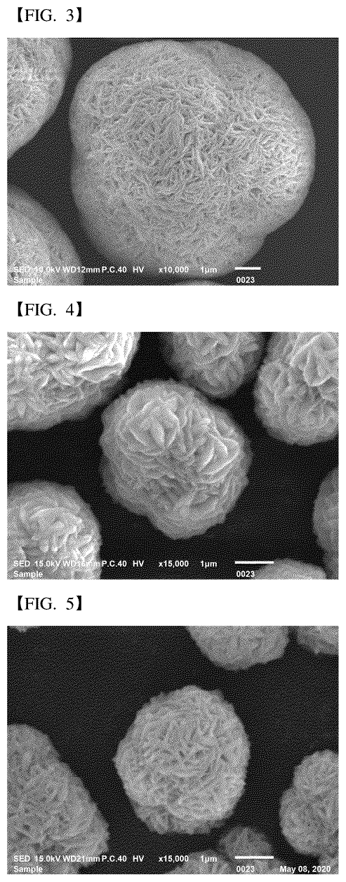

The SEM image of the second precursor thus prepared is shown in FIG. 5 and it can be seen from FIG. 5 that the primary particles constituting the secondary particles have a needle shape.

Then, a cathode active material was prepared in the same manner as in Example 1 using the first and second precursors prepared in Example 2.

### Example 3

A composite transition metal hydroxide powder (first precursor) with a D50 of 10 μm was prepared in the same manner as in Example 1 except that the pH of the synthesized result in the reactor was adjusted to 11.7 to 11.8 and the ammonia concentration in the reactor was adjusted to 3,000 to 4,000 ppm.

The SEM image of the first precursor thus prepared is shown in FIG. 3 and it can be seen from FIG. 3 that the primary particles constituting the secondary particles have a needle shape.

A composite transition metal hydroxide powder (second precursor) with a D50 of 4 μm was prepared in the same manner as in Example 1 except that the pH of the synthesized result in the reactor was adjusted to 12.5 to 12.6 and the ammonia concentration in the reactor was adjusted to 7,000 to 8,000 ppm.

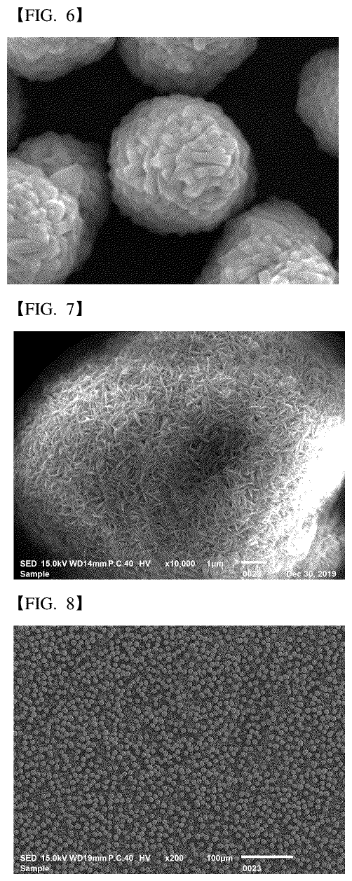

The SEM image of the second precursor thus prepared is shown in FIG. 6 and it can be seen from FIG. 6 that the primary particles constituting the secondary particles have a rod shape.

Then, a cathode active material was prepared in the same manner as in Example 1 using the first and second precursors prepared in Example 3.

### Example 4

A composite transition metal hydroxide powder (first precursor) with a D50 of 16 μm was prepared in the same manner as in Example 1 except that the pH of the synthesized result in the reactor was adjusted to 12.3 to 12.4, the ammonia concentration in the reactor was adjusted to 8,000 to 10,000 ppm and synthesis was performed by stirring at 380 rpm for 30 hours.

The SEM image of the first precursor thus prepared is shown in FIG. 7 and it can be seen from FIG. 7 that the primary particles constituting the secondary particles have a needle shape.

A composite transition metal hydroxide powder (second precursor) with a D50 of 4 μm was prepared in the same manner as in Example 1.

Then, a cathode active material was prepared in the same manner as in Example 1 using the first and second precursors prepared in Example 4.

The first precursor and the second precursor prepared in Example 4 and a combination thereof can be seen from FIG. 10. The combination of the large-diameter and small-diameter precursors can be seen from the results of PSD particle diameter distribution analysis of FIG. 11.

An SEM image of the cathode active material prepared from the first and second active materials prepared in Example 4 is shown in FIG. 17.

### Comparative Example 1

A composite transition metal hydroxide powder (first precursor) with a D50 of 10 μm was prepared in the same manner as in Example 1 except that the pH of the synthesized result in the reactor was adjusted to 12.3 to 12.4 and the ammonia concentration in the reactor was adjusted to 8,000 to 9,000 ppm.

The SEM image of the first precursor thus prepared is shown in FIG. 12 and it can be seen from FIG. 12 that the primary particles constituting the secondary particles have a plate shape.

A composite transition metal hydroxide powder (second precursor) with a D50 of 4 μm was prepared in the same manner as in Example 1 except that the pH of the synthesized result in the reactor was adjusted to 11.2 to 11.3 and the ammonia concentration in the reactor was adjusted to 3,000 to 4,000 ppm.

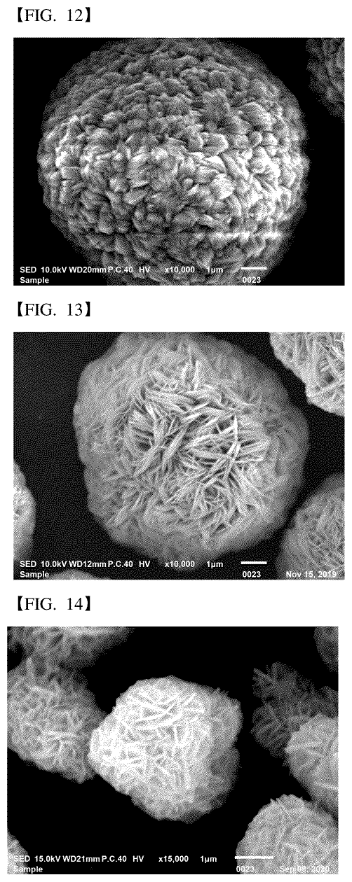

The SEM image of the second precursor thus prepared is shown in FIG. 14 and it can be seen from FIG. 14 that the second precursor has a needle structure in which spaces are present between the primary particles constituting the secondary particles.

Then, a cathode active material was prepared in the same manner as in Example 1 using the first and second precursors prepared in Comparative Example 1.

### Comparative Example 2

A composite transition metal hydroxide powder (first precursor) with a D50 of 10 μm was prepared in the same manner as in Example 1 except that the pH of the synthesized result in the reactor was adjusted to 12.6 to 12.7 and the ammonia concentration in the reactor was adjusted to 7,000 to 8,000 ppm.

The SEM image of the first precursor thus prepared is shown in FIG. 13 and it can be seen from FIG. 13 that the second precursor has a needle structure in which spaces are present between the primary particles constituting the secondary particles.

A composite transition metal hydroxide powder (second precursor) with a D50 of 4 μm was prepared in the same manner as in Example 1 except that the pH of the synthesized result in the reactor was adjusted to 12.6 to 12.7 and the ammonia concentration in the reactor was adjusted to 7,000 to 8,000 ppm.

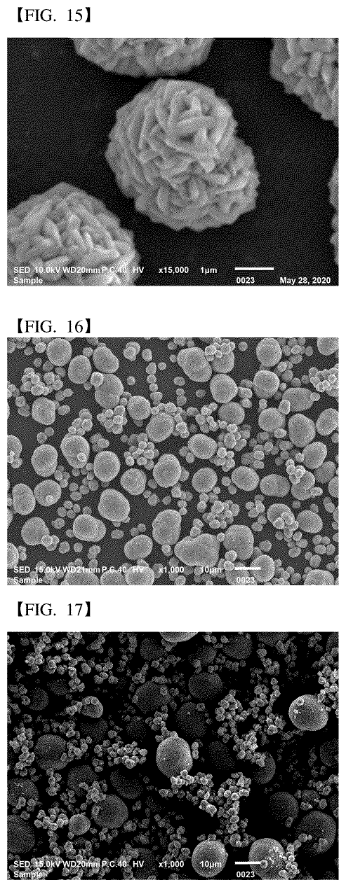

The SEM image of the second precursor thus prepared is shown in FIG. 15 and it can be seen from FIG. 15 that the primary particles constituting the secondary particles have a rod structure.

Then, a cathode active material was prepared in the same manner as in Example 1 using the first and second precursors prepared in Comparative Example 2.

### [Experimental Example 1]—BET Measurement

The BET of the first and second precursors included in the precursors for cathode active materials prepared in Examples 1 to 4 and Comparative Examples 1 and 2 were measured and the results are shown in Table 1 below.

TABLE 1

| | | | | | | | | | Comparative | | Comparative | |
|---|---|---|---|---|---|---|---|---|---|---|---|---|
| | Example 1 | | Example 2 | | Example 3 | | Example 4 | | Example 1 | | Example 2 | |
| | First | Second | First | Second | First | Second | First | Second | First | Second | First | Second |
| | pre- | pre- | pre- | pre- | pre- | pre- | pre- | pre- | pre- | pre- | pre- | pre- |
| | cursor | cursor | cursor | cursor | cursor | cursor | cursor | cursor | cursor | cursor | cursor | cursor |
| BET (m²/g) | 5.9 | 6.27 | 8.39 | 15.52 | 7.87 | 4.10 | 9.12 | 6.27 | 3.21 | 25.38 | 13.17 | 3.39 |
| First | 0.94 | | 0.54 | | 1.92 | | 1.45 | | 0.13 | | 3.88 | |
| precursor/ | | | | | | | | | | | | |
| Second | | | | | | | | | | | | |
| precursor | | | | | | | | | | | | |

As can be seen from Table 1, the precursors for the cathode active materials in Comparative Examples 1 and 2 did not satisfy the BET ranges of the first and second precursors proposed in the present invention and were relatively large or small, and the ratio of the BET of the first precursor to the BET of the second precursor (BET of the first precursor/BET of the second precursor) was less than 0.3 or greater than 3.5.

On the other hand, it can be seen that precursors for cathode active materials in Examples 1 to 4 satisfied both the BET ranges and the BET ratio ranges.

### [Experimental Example 2]—Measurement of Electrochemical Properties

The cathode active material prepared in each of Examples 1 to 4 and Comparative Examples 1 and 2, a conductive agent and a binder were mixed at a ratio of 92:5:3 (active material:conductive agent:binder), and the resulting mixture was applied to a copper current collector and then dried to produce a cathode. A secondary battery was manufactured using lithium metal as an anode and adding an electrolyte (1 M LiPF₆ in EC:EMC=1:2), the electrochemical properties thereof were measured, and the results are shown in Table 2 below.

TABLE 2

| | | | | | | Comparative | Comparative |
|---|---|---|---|---|---|---|---|
| | | Example 1 | Example 2 | Example 3 | Example 4 | Example 1 | Example 2 |
| CC | | 240.6 | 240.4 | 240.1 | 240 | 236.1 | 235.7 |
| DD | | 217.4 | 217.9 | 216.7 | 217.1 | 205 | 207.4 |
| Eff. | | 90.36 | 90.64 | 90.25 | 90.46 | 86.83 | 87.99 |
| Cycle | 30^{th} | 95.5 | 95.8 | 95.2 | 95.2 | 89.7 | 90 |
| retention | | | | | | | |
| DCIR | 30^{th} | 26.2 | 26.7 | 25.9 | 23.5 | 59 | 59.3 |

As can be seen from Table 2, Examples 1 to 4 exhibited superior capacity, efficiency, cycle characteristics, and resistance characteristics compared to Comparative Examples 1 and 2, which is presumed to be due to the fact that, as the diffusion of lithium into the first and second precursors in precursors for cathode active materials of Examples 1 to 4 is optimized even at a single sintering temperature, properties of cathode active materials prepared therefrom are improved.

Although preferred embodiments of the present invention have been disclosed for illustrative purposes, those skilled in the art will appreciate that various modifications, additions and substitutions are possible, without departing from the scope and spirit of the invention as disclosed in the accompanying claims.

1. A transition metal-containing precursor for preparing a cathode active material for a lithium secondary battery,
wherein the transition metal-containing precursor comprises a first precursor and a second precursor having an average particle diameter (D50) smaller than that of the first precursor, and has a ratio of a BET of the first precursor to a BET of the second precursor (BET of first precursor/BET of second precursor) of 0.3 to 3.5.

2. The transition metal-containing precursor according to claim 1, wherein a ratio of an average particle diameter (D50) of the first precursor to an average particle diameter (D50) of the second precursor (average particle diameter of the first precursor/average particle diameter of the second precursor) is 1.2 or more.

3. The transition metal-containing precursor according to claim 2, wherein the ratio of the average particle diameter (D50) of the first precursor to the average particle diameter (D50) of the second precursor (average particle diameter of the first precursor/average particle diameter of the second precursor) is 1.2 to 10.

4. The transition metal-containing precursor according to claim 1, wherein the average particle diameter (D50) of the first precursor is in the range of 10 μm to 20 μm, and the average particle diameter of the second precursor is in the range of 2 μm to 8 μm.

5. The transition metal-containing precursor according to claim 1, wherein the first precursor has a BET of 5.5 m²/g to 12.0 m²/g and the second precursor has a BET of 3.5 m²/g to 16.0 m²/g.

6. The transition metal-containing precursor according to claim 1, wherein the first precursor and the second precursor are mixed at a weight ratio of 9:1 to 6:4 (first precursor:second precursor).

7. The transition metal-containing precursor according to claim 1, wherein the first precursor has a tap density (TD) of 1.9 g/cc or less and the second precursor has a TD of 1.2 g/cc or more.

8. The transition metal-containing precursor according to claim 1, wherein at least one of the first precursor and the second precursor comprises a chemical composition of the following Formula 1:
Ni_{1-(a+b+c)}CoₐMn_{b}M_{c}(OH_{1-d})₂ (1)
wherein M comprises one or two or more elements selected from the group consisting of B, Al, Ti, Sc, V, Cr, Fe, Y, Cu, Zr, Nb, Mo, Tc, Ru, Rh, Ag, Pd, P, and W; and
a, b, c, and d satisfy 0≤a<0.4, 0≤b<0.4, 0≤c<0.4, and 0≤d≤0.5, respectively, with the proviso of 0<a+b and 0<a+b+c≤0.4.

9. A cathode active material for a lithium secondary battery prepared by co-sintering the transition metal-containing precursor according to claim 1 with a lithium precursor.
